(19) United States
(12) Patent Application Publication
(10) Pub. No.: US 2023/0252317 A1
(43) Pub. Date: Aug. 10, 2023

(54) DEVICE AND COMPUTER-IMPLEMENTED METHOD FOR OPERATING A MACHINE

(71) Applicant: Robert Bosch GmbH, Stuttgart (DE)

(72) Inventors: Johannes Oetsch, Wien (AT); Michael Pritz, Wien (AT); Nelson Higuera, Wien (AT); Thomas Eiter, Wien (AT)

(21) Appl. No.: 18/157,535

(22) Filed: Jan. 20, 2023

(30) Foreign Application Priority Data
Feb. 9, 2022 (DE) 10 2022 201 341.7

(51) Int. Cl. G06N 5/022

(52) U.S. Cl. CPC G06N 5/022

(57) ABSTRACT

A device and method for operating a machine. The method comprises providing a digital image, providing a structured representation of a question, predicting with an object detector and depending on at least a part of the digital image an area of the digital image wherein an object is depicted in the digital image, predicting with a classifier and depending on at least a part of the digital image within the area a first score indicating a likelihood that the object is of a first class and a second score indicating a likelihood that the object is of a second class, providing at least one attribute value for the first class, adding to an answer set programming program a first rule comprising the at least one attribute value of the first class and/or a first constraint comprising the at least one attribute value of the first class.

### CROSS REFERENCE

The present application claims the benefit under 35 U.S.C. § 119 of German Patent Application No. DE 10 2022 201 341.7 filed on Feb. 9, 2022, which is expressly incorporated herein by reference in its entirety.

### FIELD

The present invention concerns a device and a computer-implemented method for operating a machine.

### BACKGROUND INFORMATION

Visual question answering may be used to improve the operation of machines. Visual question answering is for example described in Antol, S., Agrawal, A., Lu, J., Mitchell, M., Batra, D., Zitnick, C. L., Parikh, D., “Vqa: Visual question answering;” in: Proceedings of the IEEE International Conference on Computer Vision. pp. 2425-2433 (2015).

### SUMMARY

The operation of a machine is further improved when operating it with a computer-implemented method and by a device according to the present invention.

According to an example embodiment of the present invention, the computer-implemented method for operating a machine, includes providing a digital image, providing a structured representation of a question, predicting with an object detector and depending on at least a part of the digital image an area of the digital image wherein an object is depicted in the digital image, predicting with a classifier and depending on at least a part of the digital image within the area a first score indicating a likelihood that the object is of a first class and a second score indicating a likelihood that the object is of a second class, wherein the first score indicates a higher likelihood than the second score, providing at least one attribute value for the first class, adding to an answer set programming program a first rule comprising the at least one attribute value of the first class and/or a first constraint comprising the at least one attribute value of the first class, with a condition determined depending on a mean value and a standard deviation of a distribution of scores that indicate for a plurality of classes their respective likelihood that an object of the respective class is detected by the object detector, determining if the second score meets the condition or not, if the second score meets the condition, providing at least one attribute value for the second class and adding to the answer set programming program a second rule comprising the at least one attribute value of the second class and/or a second constraint comprising the at least one attribute value of the second class, adding at least one fact to the answer set programming program depending on the structured representation of the question, determining with an answer set solver an answer to the answer set programming program, wherein the answer comprises at least one attribute value of the first class and/or at least one attribute value of the second class, operating the machine depending on the answer.

Preferably, the machine is a robot and/or a vehicle, wherein the method comprises detecting the digital image with at least one sensor, in particular a camera, a radar sensor, a lidar sensor, an ultrasonic sensor, an infrared sensor, a motion sensor.

According to an example embodiment of the present invention, the method preferably comprises providing the digital image comprising at least one object representing a sign, in particular a traffic sign, a surface, in particular a traffic surface, or a user, in particular a pedestrian or a vehicle, wherein the at least one attribute value of the first class and the at least one attribute value of the second class indicates a type thereof, and providing the structured representation of the question to comprise at least one attribute value of the at least one attribute value of the first class and the at least one attribute value of the second class.

The method may comprise determining an action depending on the at least one attribute value that the answer comprises.

Preferably, according to an example embodiment of the present invention, the method comprises determining the action to comprise stopping the machine, in particular performing an emergency stop, in case the attribute value of the object representing the sign indicates that the sign is a stop sign or the attribute value of the object representing the pedestrian indicates that the pedestrian is a child.

According to an example embodiment of the present invention, the method preferably comprises providing a set of classes including the first class and the second class, providing a set of digital images, determining with the object detector for the digital images in the set of digital images their respective area, determining with the classifier for the areas of the digital images in the set of digital images respective scores for the classes in the set of classes, wherein each score indicates the likelihood that an object that is depicted in the respective area is of one of the classes, and determining the mean value depending on a sum of one score per area, in particular the maximum of the scores, that are assigned to the classes in this area.

Preferably, according to an example embodiment of the present invention, the method comprises determining for the one scores per area their respective difference to the mean, and determining the standard deviation depending on these differences.

Preferably, according to an example embodiment of the present invention, the method comprises determining a threshold depending on a difference between the mean and the standard deviation in particular weighted with a parameter, and determining that the condition is met, if the second score is equal to or larger than the threshold.

Preferably, according to an example embodiment of the present invention, the method comprises adding the second rule and/or the second constraint to the answer set programming program if the second score fails to meet the condition and if the second score is within a predetermined set of scores.

Preferably, according to an example embodiment of the present invention, the method comprises determining a plurality of scores for a plurality of classes, wherein each score indicates the likelihood that an object that is depicted in the area is of one of the classes, adding to the set of scores an amount of scores from the plurality of scores, in particular the amount of highest scores of the plurality of scores.

Preferably, according to an example embodiment of the present invention, the method comprises providing the first constraint with a first weight for weighting the first constraint and determining the answer depending on the first constraint weighted with the first weight and/or providing the second constraint with a second weight for weighting the second constraint, and determining the answer depending on the second constraint weighted with the second weight.

Preferably, according to an example embodiment of the present invention, the method comprises determining the first weight depending on the first confidence score and/or determining the second weight depending on the second confidence score.

According to an example embodiment of the present invention, the device for operating a machine comprises an input for digital images, an object detector for detecting objects depicted in digital images, a classifier for classifying objects detected by the object detector, an input for questions, an answer set solver for determining answers to questions, and an output for instructions to operate the machine depending on answers determined by the answer set solver in accordance with the method.

The device 104 may comprise at least one sensor 118 for capturing the digital images and/or at least one actuator 120 for operating the machine 102 according to the instructions.

According to one example, a computer program comprises instructions that, when executed by a computer, cause the computer to executed the method.

Further advantageous embodiments are derived from the following description and the figures.

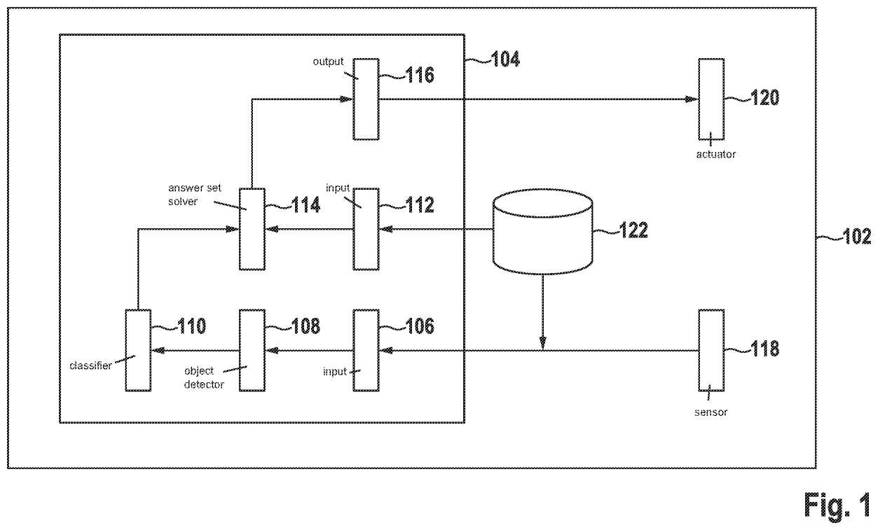

FIG. 1 schematically depicts a machine and a device for operating the machine, according to an example embodiment of the present invention.

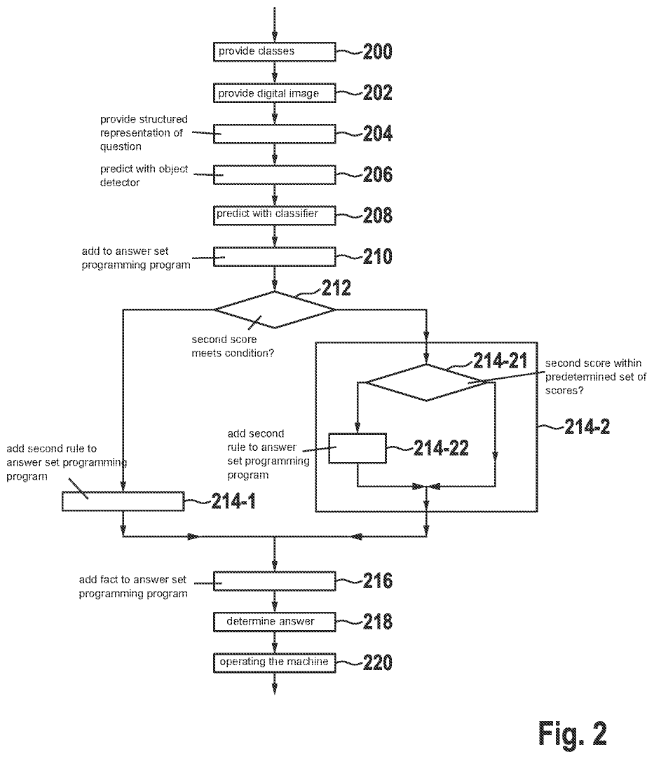

FIG. 2 depicts a flow chart of a method for operating the machine, according to an example embodiment of the present invention.

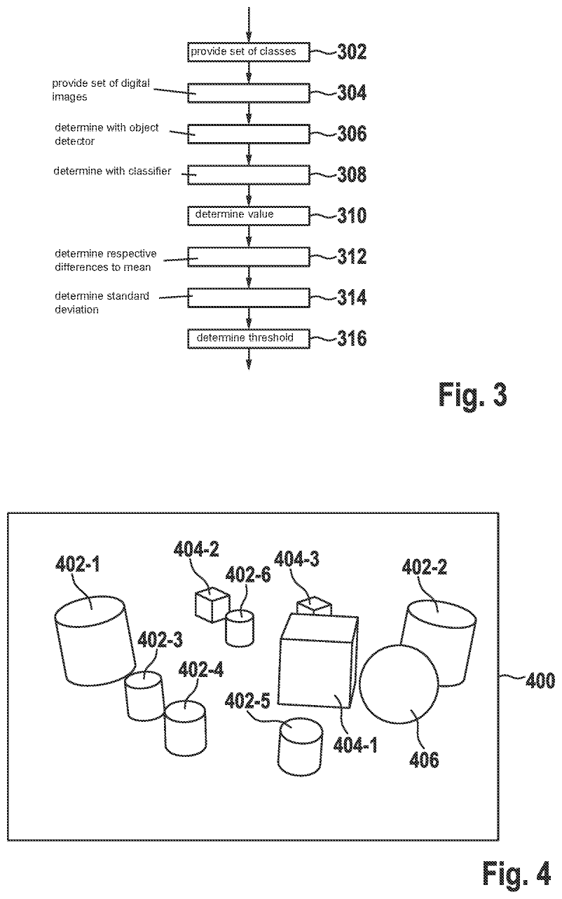

FIG. 3 depicts a flow chart of a part of the method, according to an example embodiment of the present invention.

FIG. 4 depicts a digital image.

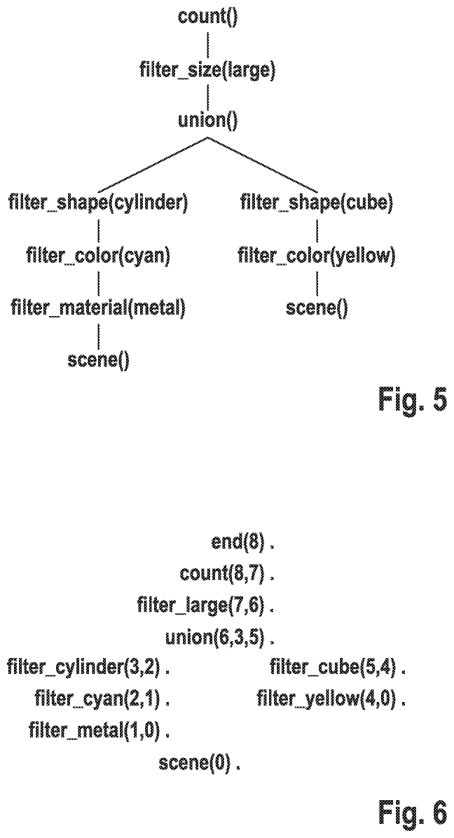

FIG. 5 depicts a functional program, according to an example embodiment of the present invention.

FIG. 6 depicts an encoding, according to an example embodiment of the present invention.

### DETAILED DESCRIPTION OF EXAMPLE EMBODIMENTS

FIG. 1 depicts a machine 102. According to an example, the machine 102 is a robot. According to an example, the machine 102 is a vehicle,

FIG. 1 depicts a device 104 for operating the machine 102.

The device 104 comprises an input 106 for digital images.

The device 104 comprises an object detector 108 for detecting objects depicted in digital images.

The device 104 comprises a classifier 110 for classifying objects detected by the object detector 108.

The device 104 comprises an input 112 for questions.

The device 104 comprises an answer set solver 114 for determining answers to questions depending on an answer set programming program.

The device 104 comprises an output 116 for instructions to operate the machine 102 depending on answers determined by the answer set solver 114.

The device 104 according to one example comprises at least one sensor 118 for capturing the digital images.

The at least one sensor 118 is for example a camera, a radar sensor, a lidar sensor, an ultrasonic sensor, an infrared sensor, and/or a motion sensor.

The device 104 according to one example comprises at least one actuator 120 for operating the machine 102 according to the instructions.

The device 104, the input 106 for digital images, the object detector 108, the classifier 110, the input 112 for questions, the answer set solver 114, and the output 116 may be implemented as at least a part of a computer program. The computer program comprises instructions that, when executed by a computer, cause the computer to executed a computer-implemented method for operating the machine 102.

In the example, the device 104 is part of the machine 102 or mounted to the machine 102. The device 104 may be arranged as separate component remote from the of the machine 102.

Digital images are provided in the example by the sensor 118. Questions are provided via the input 112. The questions may be predetermined questions that are read from storage 122. Digital images may be provided, e.g. for a training, from storage 122 as well. The storage 122 may be external to the device 104 or internal. A computer program comprising instructions for operating the machine 102 is provided in one example. The functions of the input 106, the object detector 108, the classifier 110, the input 112, the answer set solver 114, and the output 116 may be implemented by the computer program. At least one processor may be provided to execute the computer program for operating the machine.

The object detector 108 may comprise an artificial neural network that is trained to detect bouding-boxes comprising an object depicted in a digital image. The classifier 110 may comprise an artificial neural network that is trained to classify objects in digital images considering the output of the objet detector 108, e.g. the bouding-boxes.

The actuator 120 may be a control system of the machine 102, e.g. a brake system or a steering system.

The computer-implemented method for operating the machine 102 comprises a step 200.

The step 200 comprises providing a plurality of classes. The plurality of classes comprises in the example classes for any object that is detectable by the object detector 108 and classifiyable by the classifier 110. The step 200 comprises providing at least one attribute value per class of the plurality of classes.

The example is described below referencing a first class and at least one attribute value of the first class. The example is described below referencing a second class and at least one attribute value of the second class. The method steps apply to other classes and the attribute values of these classes as well.

The computer-implemented method for operating the machine 102, comprises a step 202.

The step 202 comprises providing a digital image. According to an example, the method comprises detecting the digital image with the at least one sensor 118.

According to an example, the method comprises providing the digital image comprising at least one object representing a sign, in particular a traffic sign. The at least one attribute value of the first class and the at least one attribute value of the second class in this example indicates a type of the sign.

According to an example, the method comprises providing the digital image comprising at least one object representing a surface, in particular a traffic surface. The at least one attribute value of the first class and the at least one attribute value of the second class in this example indicates a type of the surface.

According to an example, the method comprises providing the digital image comprising at least one object representing a user, in particular a pedestrian or a vehicle. The at least one attribute value of the first class and the at least one attribute value of the second class in this example indicates a type of the user.

The method not limited to these exemplary classes. The method may comprise providing classes of different objects and providing attribute values describing these classes.

The computer-implemented method for operating the machine 102, comprises a step 204.

The step 204 comprises providing a structured representation of a question. The structured representation of the question is provided in the example at the input 112.

According to an example, the step 204 comprises providing the structured representation of the question to comprise the at least one attribute value of the first class. According to an example, the step 204 comprises providing the structured representation of the question to comprise the at least one attribute value of the second class. The structured representation of the question may comprise one or more of these attribute values.

The computer-implemented method for operating the machine 102, comprises a step 206.

The step 206 comprises predicting with the object detector 108 and depending on at least a part of the digital image an area of the digital image wherein an object is depicted in the digital image.

The area may be a rectangular bounding-box. The bounding-box may be represented by the coordinates x₁,y₁ of a top left corner of the bounding-box and the coordinates x₂,y₂ of a bottom right corner of the bounding-box. The method is not limited to this shape and coordinates of the bounding box. Other shapes, e.g. oval or circular shapes and suitable representations thereof may be used as well.

The computer-implemented method for operating the machine 102, comprises a step 208.

The step 208 comprises predicting with the classifier 110 and depending on at least a part of the digital image within the area a first score indicating a likelihood that the object is of the first class.

The step 208 comprises predicting with the classifier 110 and depending on at least a part of the digital image within the area a second score indicating a likelihood that the object is of the second class.

The first score indicates a higher likelihood than the second score.

The step 208 may comprise determining a plurality of scores for a plurality of classes, wherein each score indicates the likelihood that an object that is depicted in the area is of one of the classes.

The computer-implemented method for operating the machine 102, comprises a step 210.

The step 210 in one example comprises adding to the answer set programming program a first rule comprising the at least one attribute value of the first class.

The step 210 in one example comprises adding to the answer set programming program a first constraint comprising the at least one attribute value of the first class.

The step 210 in one example comprises providing the first constraint with a first weight for weighting the first constraint.

The method may comprise determining the first weight depending on the first score.

The computer-implemented method for operating the machine 102, comprises a step 212.

The step 212 comprises determining, if the second score meets a condition or not.

Determining that the condition is met may comprise determining if the second score is equal to or larger than a predetermined threshold.

Determining the condition is described below referencing FIG. 3. The condition depends on a mean value and a standard deviation of a distribution of scores that indicate for a plurality of classes their respective likelihood that an object of the respective class is detected by the object detector 108.

Determining the threshold is described below referencing FIG. 3

If the second score meets the condition a step 214-1 is executed.

Otherwise a step 214-2 is executed.

The step 214-1 comprises in one example adding to the answer set programming program a second rule comprising the at least one attribute value of the second class.

The step 214-1 comprises in one example adding a second constraint comprising the at least one attribute value of the second class.

The method may comprise providing the second constraint with a second weight for weighting the second constraint.

The method may comprise determining the second weight depending on the second score.

Afterwards a step 216 is executed.

In the step 214-2, the method may comprise a step 214-21 of determining whether if the second score is within a predetermined set of scores. If the second score is within the predetermined set of scores a step 214-22 is executed. Otherwise the step 216 is executed.

In the step 214-21, the method may comprise adding to the set of scores an amount of scores from the plurality of scores, in particular the amount of highest scores of the plurality of scores.

In the step 214-22, the method may comprise adding the second rule to the answer set programming program. This means, the second rule is added, if the second score fails to meet the condition and if the second score is within a predetermined set of scores.

The step 214-22 comprises adding the second constraint to the answer set programming program. This means, the second constraint is added, if the second score fails to meet the condition and if the second score is within a predetermined set of scores.

The method may comprise providing the second constraint with the second weight for weighting the second constraint.

The method may comprise determining the second weight depending on the second confidence score.

If the second score fails to meet the condition and if the second score is not within the predetermined set of scores, neither the second rule nor the second constraint is added.

Afterwards the step 216 is executed.

In the step 216 the method comprises adding at least one fact to the answer set programming program depending on the structured representation of the question.

Afterwards a step 218 is executed.

In the step 218 the method comprises determining with the answer set solver 114 an answer to the answer set programming program.

The answer comprises at least one attribute value of the first class. The answer set programming program may comprise at least one attribute value of the second class.

In the step 218 the method may comprise determining the answer depending on the first constraint weighted with the first weight.

In the step 218 the method may comprise determining the answer depending on the second constraint weighted with the second weight.

Afterwards a step 220 is executed.

In the step 220 the method comprises operating the machine 102 depending on the answer.

The step 220 may comprise determining an action depending on the at least one attribute value that the answer comprises.

The method may comprise determining the action to comprise stopping the machine 102.

In case the answer comprises the attribute value of the object representing the sign, the method may comprise performing an emergency stop of the machine 102, in case the attribute value of the object representing the sign indicates that the sign is a stop sign.

In case the answer comprises the attribute value of the object representing the pedestrian, the method may comprise performing an emergency stop of the machine 102, in case the attribute value of the object representing the pedestrian indicates that the pedestrian is a child.

Determining the condition is described referencing FIG. 3.

The method may comprise determining the condition.

Determining the condition comprises a step 302. The step 302 comprises providing a set of classes including the first class and the second class. The plurality of classes may be provided as described in step 200.

Determining the condition comprises a step 304.

The step 304 comprises providing a set of digital images.

The set of digital images may comprise the digital image described above or different digital images.

Determining the condition comprises a step 306.

The step 306 comprises determining with the object detector 108 for the digital images in the set of digital images their respective area.

Determining the condition comprises a step 308.

The step 308 comprises determining with the classifier 110 for the areas of the digital images in the set of digital images respective scores for the classes in the set of classes. Each score indicates the likelihood that an object that is depicted in the respective area is of one of the classes.

Determining the condition comprises a step 310.

The step 310 comprises determining the mean value depending on a sum of one score per area. In the example, the sum is determined with the maximum of the scores, that are assigned to the classes in this area.

Determining the condition comprises a step 312.

The step 312 comprises determining for the one scores per area their respective difference to the mean.

Determining the condition comprises a step 314.

The step 314 comprises determining the standard deviation depending on these differences.

Determining the condition comprises a step 316.

The step 316 comprises determining the threshold depending on a difference between the mean and the standard deviation. The standard deviation according to one example is weighted with a parameter.

By way of example, aspects of the method are described for CLEVR scenes.

CLEVR, according to Johnson, J., Hariharan, B., van der Maaten, L., Fei-Fei, L., Zitnick, C. L., Girshick, R. B., “CLEVR: A diagnostic dataset for compositional language and elementary visual reasoning;” in: 2017 IEEE Conference on Computer Vision and Pattern Recognition, (CVPR 2017). pp. 1988-1997. IEEE Computer Society (2017) is a dataset designed to test and diagnose the reasoning capabilities of visual question answering systems, VQA.

CLEVR comprises digital images showing scenes, referred to as CLEVR images or CLEVR scenes, with objects and questions related to them. CLEVR comprises at least one question per CLEVR image that is related to a scene depicted in the CLEVR image. The entire set is available at https://cs.stanford.edu/people/jcjohns/clevr/.

An exemplary CLEVR image 400 is described with reference to FIG. 4.

The CLEVR image 400 depicts a scene with objects in it. The objects differ by the values of their attributes, which are e.g. size (big, small), color (brown, blue, cyan, grey, green, purple, red, yellow), material (metal, rubber), and shape (cube, cylinder, sphere). The CLEVR image 400 is provided with a ground truth scene graph describing the scene depicted in it.

The CLEVR image 400 is from the CLEVR validation dataset and corresponds to a question “How many large things are either cyan metallic cylinders or yellow blocks?”. The ground truth scene graph comprises “0” as answer to this question.

The CLEVR image 400 is an example for the digital image. The CLEVR image comprises the following objects:
402-1: big grey metal cylinder
402-2: big blue rubber cylinder
402-3: small green metal cylinder
402-4: small yellow rubber cylinder
402-5: small cyan rubber cylinder
402-6: small blue metal cylinder,
404-1: large blue metal cube,
404-2: small cyan metal cube,
404-3: small yellow metal cube,
406: large purple sphere.

A question in CLEVR is constructed using a functional program, which represents one or more questions. The structured format in the example is determined depending on a functional program. This means, the functional program is a symbolic template for a question. The template maps to a natural language sentences, i.e. question, when the template is instantiated with corresponding values.

FIG. 5 depicts an example for the functional program representing e.g. the natural language question “How many large things are either cyan metallic cylinders or yellow cubes”.

A function scene( ) returns a set of objects of the CLEVR scene. Filter functions, in the example filter_size(large), filter_shape(cylinder), filter_color(cyan), filter_material(metal), filter_shape(cube), filter_color(yellow), restrict a set of objects output by the function scene( ) to subsets with respective properties as indicated by the argument of the respective function. A function union( ) yields a union of two sets, and a function count( ) returns a number of elements of a set.

The method is not limited to CLEVR. The structured format of the question may be determined from any other source. Other functional programs of CLEVR may be used as well.

In one example, a neural network is trained with training data from CLEVR for bounding-box prediction and object classification for processing CLEVR scenes.

The training data comprises pairs of a CLEVR scene and the bounding-box predictions that shall be determined by the neural network for this CLEVR scene. The training data also contains the objects present in the CLEVR image related to the bounding boxes.

For example YOLOv3, Redmon, J., Farhadi, A., “Yolov3: An incremental improvement;” CoRR abs/1804.02767 (2018) is used for bounding-box prediction and object classification.

The output of the object detector 108 in this example is a matrix X whose rows correspond to the bounding-box predictions in the digital image at the input 106.

A bounding-box prediction in this case is a vector of the form (c₁, . . . , cₙ, x₁, y₁, x₂, y₂) wherein c₁, . . . , cₙ are scores of different classes and the pair x₁,y₁ gives the top-left corner point of the bounding box and x₂,y₂ gives the bottom-right corner point of the bounding box.

Furthermore, the scores c₁, . . . , cₙ indicate a likelihood with cᵢ∈[0,1] for 1≤i≤n

The higher the score the higher the likelihood of a correct prediction.

Each cᵢ represents a score for a specific combination of object attributes, e.g. size, color, material and shape, and their respective values. This specific combination is referred to as object class of position i.

According to this example, for any object class c a list c̅ of its attribute values, e.g. (size; shape; material; color), is provided.

For example, assume c represents an object class “large red metallic cylinder”, then c̅=large, red, metallic, cylinder. Note that there are n=96 object classes in CLEVR.

According to one example, the object detector 108 is configured to determine a bounding-box confidence score for every row of the matrix X. According to this example, every row corresponds to one bounding-box prediction of the object detector 108. In one example, not all of the bounding-boxes are used in the method. For example, a number of bounding-boxes that are used depends on a bounding-box threshold. The bounding-box threshold in one example is a hyper-parameter used to filter out rows with a low confidence score. The bounding-box threshold is set for example to 0.5. In this example, predictions of the object detector 108 that have a confidence score below 0.5 are discarded, i.e. not present in the matrix X. This reduces the amount of rows in the matrix X and allows a more efficient processing of the further steps. This reduces the computing resources that are required to determine the answer.

In one example, the threshold is determined for predictions of a neural network that is trained to bounding-box and object classification of digital images. This will be explained below for the neural network that is trained with the training data from CLEVR for bounding-box prediction and object classification for processing CLEVR scenes.

The threshold for these network predictions is determined by statistical analysis on a distribution of prediction values, i.e. the scores, that the trained neural network produces for test data. The test data comprises pairs of a CLEVR scene and the bounding-box predictions that shall be determined by the neural network for this CLEVR scene.

The method comprises determining classes that have a reasonable high score and discard ones that have a low score depending on the scores c₁, . . . , cₙ. This makes the subsequent reasoning process more efficient and reduces the computing resources that are required to determine the answer.

Using a fixed threshold hardly achieves this, since it does not take into account the distribution of scores in the application area. The distribution of scores in the example is determined with the test data. The test data is for example validation data that was used for training the object detector 108, e.g. the validation data from CLEVR.

The threshold in the example is based on the mean and the standard deviation of scores. The mean μ and the standard deviation σ is for example determined for a set of m digital images depending on a list of matrices X¹, . . . , X^{m}, wherein the matrix Xⁱ; i=1, . . . , m is the matrix X determined by the object detector 108 for the i-th digital image in the set of m digital images:

$$μ = \frac{1}{{\sum }_{k = 1}^{m} {N}^{k}} {\sum }_{k = 1}^{m} {\sum }_{i = 1}^{{N}^{k}} {max}_{1 \leq j \leq n} {X}_{i , j}^{k}$$

$$σ = \sqrt{\frac{1}{{\sum }_{k = 1}^{m} {N}^{k}} {\sum }_{k = 1}^{m} {\sum }_{i = 1}^{{N}^{k}} {( {max}_{1 \leq j \leq n} ( {X}_{i , j}^{k} ) - μ )}^{2}}$$

where Xⁱ is of the dimension Nⁱ×M.

In one example, the threshold θ is determined as

θ=max(μ−α·σ,0).

In this example α is a parameter. The parameter is e.g. zero or a positive value and provided by a user.

Determining the answer set programming program, ASP, comprises encoding the question and encoding the scene.

ASP is a declarative problem-solving paradigm, where a problem is encoded as a logic program such that the models of the program, the answer sets, correspond to the solutions of the problem. Answer sets can be computed using the answer set solver 114. Potasco, https://potassco.org/, and dlvsystem, http://www.dlvsystem.com/, are examples of the answer set solver 114.

Brewka, G., Eiter, T., Truszczy'nski, M., “Answer set programming at a glance;” Communications of the ACM 54(12), 92-103 (2011), and Gebser, M., Kaminski, R., Kaufmann, B., Schaub, T.; “Answer Set Solving in Practice;” Synthesis Lectures on Artificial Intelligence and Machine Learning, Morgan & Claypool Publishers (2012) describe ASP concepts.

An ASP program may comprise a set of rules of the form

a₁| . . . |aₖ←b₁, . . . ,bₘ,not c₁, . . . ,not cₙ

wherein aᵢ, bⱼ, cₗ are atoms, not denotes a default negation and k, m, n≥0. A head of the rule is a₁| . . . |aₖ a body of the rule is b₁, . . . , bₘ, not c₁, . . . , not cₙ. The rule expresses, whenever all atoms b₁, . . . , bₘ in the body are true, and there is no default negated atom not c₁, . . . , not cₙ, then some atom in the head has to be true. If k=1 and m=n=0 the rule is refered to as fact and the body and the left arrow ← are omitted. A fact represents definite knowledge, since its body is always satisfied. A rule with an empty head is called constraint and is used to eliminate unwanted answer sets.

An interpretation I is a set of atoms. An interpretation I satisfies the rule if it contains at least one atom aᵢ from its heads whenever it satisfies its body, i.e. {b₁, . . . , bₘ}⊆I and {c₁, . . . , cₙ}#I=Ø holds.

Furthermore, interpretation I is a model of a program P if I satisfies each rule in P. An answer-set of P is a model of P where each atom can be derived in a consistent and non-circular way.

A choice rule is of the form:

i{a₁; . . . ;aₖ}j←b₁, . . . ,bₘ,not c₁, . . . ,not cₙ

This rule defines, that, when its body is satisfied, at least I and at most j atoms from {a₁; . . . ; aₖ} must be true in every answer set. In a case i=j an answer set programming program i{a₁; . . . ; aₖ}i may be encoded as

{a₁; . . . ; aₖ}=i

A weak constraint is a rule of the form

[symbol]

b₁, . . . ,bₘ,not c₁, . . . ,not cₙ·[w]

where [w] is a integer weight. This rule defines that, whenever the body of a weak constraint is satisfied in an answer set, then a penalty of [w] is incurred. The optimal answer sets are those minimizing the total penalty of all weak constraints.

While the modelling language of answer set solvers contain variables, answer set programming is in essence a propositional formalism where variables are replaced by constant symbols in a preprocessing step called grounding, and a program with variables is effectively a shorthand for its ground version. For illustration, consider the following program, where variables start with an upper-case letter, and constant symbols are lower case:

p(a)·p(b).

q(X)←p(X).

The last rule will be replaced by the two ground rules

q(a)←p(a).

q(b)←p(b).

Encoding a question comprises for example translating the functional program that represents the natural language question into an ASP fact representation.

Encoding the question in the example comprises per CLEVR scene translating a CLEVR functional program that represent a question into an ASP program.

This is explained for the question “How many large things are either cyan metallic cylinders or yellow cubes?”. The functional program for this question is depicted by the ASP facts depicted in FIG. 6. The structure of the functional program is encoded using indices 0 to 8, that refer either to an output, if it's the first or only argument or an input, if it's another argument of a respective function.

There, function scene( ) returns a set of objects of the CLEVR scene, the filter functions, in the example filter_large( ), filter_cylinder( ), filter_cyan( ), filter_metal( ), filter cube( ), filter_yellow( ), restrict a set of objects to subsets with respective properties, union( ) yields the union of two sets, count( ) returns the number of elements of a set and end( ) outputs its input as answer to the question.

Encoding a scene comprises translating bounding-box predictions of the object detector 108 into an ASP rule and/or an ASP constraint. In the example, encoding the scene comprises per CLEVR scene translating the network predictions that the trained neural network outputs for this CLEVR scene and that pass that confidence threshold into an ASP program.

The translation is described for the matrix X and the threshold θ and for k, 1≤k≤96.

A row Xᵢ of the matrix X is determined to comprise the scores c₁, . . . , cₙ. The row Xᵢ is determined to comprise the bounding-box corners x₁,y₁ and x₂,y₂.

In the example, a set Cᵢ is determined that contains l classes with a score c greater than or equal to the threshold θ.

If no such class exists, the set Cᵢ is determined to contain the l=k classes with highest scores of the scores c₁, . . . , cₙ. This means, k is a fall-back parameter that ensures that some l classes are selected in case all scores are low.

In the example, the objects with sufficiently high confidence score are considered for computing the answer. For these, the row Xᵢ is translated to a ASP choice rule of form:

{obj(O,i,c̅₁̅,x₁,y₁,x₂,y₂), . . . ,obj(O,i,c̅ₗ̅,x₁,y₁,x₂,y₂)}

wherein c̅₁̅, . . . c̅ₗ̅ represent the list of attribute values of the l classes for that the score is equal to or larger than the threshold θ.

In one example, for these l classes a constraint is added:

[symbol]

obj(O,i,c̅,x₁,y₁,x₂,y₂)[w_{c}]

wherein c̅ indicates the list of attribute values of the class the constraint is added for, and w_{c} is a weight. The weight is for example defined as [1000−c·1000] and c is the score for the class in the row Xᵢ.

This achieves that object selections are penalized by the weight which corresponds to the object's score.

In one example, resulting answer sets are ordered according to the total score of the involved object predictions, i.e. rows Xᵢ. This encoding represents a non-deterministic scene encoding.

A deterministic scene encoding may be used instead, where each set Cᵢ is defined to contain only the single object class with the highest score.

According to an example, filter functions, in particular CLEVR filter functions, that restrict the sets of objects, are translated to ASP encodings. This is explained by way of example for a rule for filter_color(yellow):

obj(T,I, . . . ,yellow, . . . )←filter_yellow(T,T₁),obj(T₁,I, . . . ,yellow, . . . )

wherein variable T indicates an output and T₁ indicates an input, I represents an object identifier. In this explanation other arguments may exist and are omitted because they are not relevant for the filter function.

The other rules, e.g. for other colors, materials, and shapes, are defined alike.

According to an example, the count function count( ) that returns the number of elements of a given set is translated to an ASP encoding:

int(T,V)←count(T,T₁),#count{I: obj(T₁,I, . . . )}=V

wherein #count is an ASP aggregate function that computes the numbers of object identifiers referenced by variable T₁.

According to an example, a set operation, e.g. intersection or union, in particular a CLEVR set operation such as intersection and union are translated to a corresponding ASP encoding. For the intersection:

obj(T,I, . . . )←and(T,T₁,T₂),obj(T₁,I, . . . ),obj(T₂,I, . . . )

and for the union:

obj(T,I, . . . )←or (T,T₁,T₂),obj(T₁,I, . . . )

obj(T,I, . . . )←or (T,T₁,T₂),obj(T₂,I, . . . )

According to an example, a uniqueness constraint, e.g. the CLEVR function unique( ) is used to assert that there is exactly one input object, and if this is the case, it is propagated to the output. The uniqueness constraint is for example translated to a corresponding ASP encoding comprising one rule for propagation and one constraint to eliminate any answer set if the uniqueness assumption is violated:

←unique(T,T₁),obj(T₁,I, . . . ),obj(T₁,I′, . . . ),I≠I′

obj(T, . . . )←unique(T,T₁),obj(T₁, . . . )

According to an example, spatial relation rules, e.g. CLEVR functions that allow to determine objects that are in a certain spatial relation with another object are translated to ASP encodings comprising a rule that allows to identify all objects that are left relative to a given reference:

obj(T,I, . . . )←relate_left(T,T₁,T₂),I≠I′,X₁<X₁′

obj(T₁,I, . . . ,X₁, . . . ),obj(T₂,I′, . . . ,X₁′, . . . ),

The rules for right, front and behind are defined alike.

According to an example, an exist rule, e.g. the CLEVR exist( ) rule returns true if the references set of objects is not empty. The exist rule is for example translated to a ASP encoding for true:

bool(T,true)←exist(T,T₁),obj(T₁, . . . )

and false:

bool(T,false)←exist(T,T₁),not bool(T,true)

According to an example, a query function that allow to return an attribute value of a referenced object is translated to a respective ASP encoding. This is described below for a query for a size of an object.

size(T,Size)←query_size(T,T₁),obj(T₁, . . . ,Size, . . . )

The query for color, material, and shape are translated alike.

According to an example, same attribute relation rules that allow selecting sets of objects if they agree on a specified attribute with a specified reference object are translated to ASP encodings. This is described below for a size attribute:

obj(T,I, . . . )←same_size(T, T₁,T₂),obj(T₁,I, . . . ,Size, . . . ),

obj(T₂,I′, . . . ,Size, . . . ),I≠I′

The same attribute relation rules for color, material, and shape are translated alike.

According to an example, integer comparison rules, e.g. CLEVR relations for comparing integers like “equals”, “less-than” and “greater-than” are translated to corresponding ASP encodings.

This is described for “equals” and applied alike to the other relations:

bool(T,true)←equal_integer(T,T₁,T₂),obj(T₁,V),int(T₁,V),int(T₂,V)

bool(T,false)←equal_integer(T,T₁,T₂),not bool(T,true)

According to an example, attribute comparison rules that check if two objects have the same attributes like size, color, material or shape, are translated to corresponding ASP encodings. This is described for size and the encodings for the other attributes are translated alike:

bool(T,true)←equal_size(T,T₁,T₂),size(T₁,V),size(T₂,V)

bool(T,false)←equal_size(T,T₁,T₂),not bool(V,true)

According to an example, rules may be used to derive the answer, e.g. an ans/1 atom that extracts the answer for the encoded question from an output of the functions at a root of the computation:

ans(V)←end(T),size(T,V)

ans(V)←end(T),color(T,V)

ans(V)←end(T),material(T,V)

ans(V)←end(T),shape(T,V)

ans(V)←end(T),bool(T,V)

ans(V)←end(T),int(T,V)

←not ans(_)

The last constraint enforces that a least one answer is derived.

To find an answer to a CLEVR question, the corresponding functional program is looked up, e.g. from storage, and translated into its ASP fact representation. These ASP facts are joined it with the ASP rules and constraints presented above.

Each answer set then corresponds to an answer, in particular a CLEVR answer, that is founded in a particular choice for objects that are present in the scene. If the deterministic scene encoding is used, there will be at most one answer set. For the non-deterministic scene encoding, there can be multiple ones. No answer set may exist due to imperfect object recognition.

What is claimed is:

1. A computer-implemented method for operating a machine, comprising the following steps:
providing a digital image;
providing a structured representation of a question;
predicting with an object detector and depending on at least a part of the digital image an area of the digital image, wherein an object is depicted in the digital image;
predicting, with a classifier and depending on at least a part of the digital image within the area, a first score indicating a likelihood that the object is of a first class and a second score indicating a likelihood that the object is of a second class, wherein the first score indicates a higher likelihood than the second score;
providing at least one attribute value for the first class;
adding to an answer set programming program a first rule including the at least one attribute value of the first class and/or a first constraint including the at least one attribute value of the first class, with a condition determined depending on a mean value and a standard deviation of a distribution of scores that indicate for a plurality of classes their respective likelihood that an object of the respective class is detected by the object detector;
determining if the second score meets the condition or not;
based on the second score meeting the condition, providing at least one attribute value for the second class, and adding, to the answer set programming program, a second rule including the at least one attribute value of the second class and/or a second constraint including the at least one attribute value of the second class;
adding at least one fact to the answer set programming program depending on the structured representation of the question;
determining, with an answer set solver, an answer to the answer set programming program, wherein the answer includes at least one attribute value of the first class and/or at least one attribute value of the second class;
operating the machine depending on the answer.

2. The method according to claim 1, wherein the machine is a robot and/or a vehicle, and wherein the method further comprises detecting the digital image with at least one sensor, the at least one sensor including a camera, or a radar sensor, or a lidar sensor, or a ultrasonic sensor, or an infrared sensor, or a motion sensor.

3. The method according to claim 1, wherein the digital image the digital image includes at least one object representing a traffic sign, or a traffic surface, or a pedestrian, or a vehicle, wherein the at least one attribute value of the first class and the at least one attribute value of the second class indicates a type thereof, and wherein the structured representation of the question includes at least one attribute value of the at least one attribute value of the first class and the at least one attribute value of the second class.

4. The method according to claim 3, further comprising:
determining an action depending on the at least one attribute value that the answer includes.

5. The method according to claim 4, wherein the at least one object includes the traffic sign or the pedestrian, and the action includes performing a stop, when the attribute value of the object representing the sign indicates that the sign is a stop sign or the attribute value of the object representing the pedestrian indicates that the pedestrian is a child.

6. The method according to claim 1, further comprising:
providing a set of classes including the first class and the second class;
providing a set of digital images;
determining with the object detector for the digital images in the set of digital images their respective area;
determining with the classifier for areas of the digital images in the set of digital images, respective scores for the classes in the set of classes, wherein each of the scores indicates a likelihood that an object that is depicted in the respective area is of one of the set of classes; and
determining the mean value depending on a sum of one score per area, that are assigned to the classes in the area.

7. The method according to claim 6, further comprising determining for the one scores per area their respective difference to the mean, and determining the standard deviation depending on the differences.

8. The method according to claim 7, further comprising determining a threshold depending on a difference between the mean and the standard deviation weighted with a parameter, and determining that the condition is met, when the second score is equal to or larger than the threshold.

9. The method according to claim 1, further comprising adding the second rule and/or the second constraint to the answer set programming program based on the second score failing to meet the condition and based on the second score being within a predetermined set of scores.

10. The method according to claim 9, further comprising:
determining a plurality of scores for the plurality of classes, wherein each score indicates a likelihood that an object that is depicted in the area is of one of the classes; and
adding to the set of scores an amount of highest scores from the plurality of scores.

11. The method according claim 1, further comprising:
providing the first constraint with a first weight for weighting the first constraint and determining the answer depending on the first constraint weighted with the first weight; and/or
providing the second constraint with a second weight for weighting the second constraint, and determining the answer depending on the second constraint weighted with the second weight.

12. The method according to claim 11, further comprising determining the first weight depending on the first score and/or determining the second weight depending on the second score.

13. A device for operating a machine, comprising:
an input for digital images;
an object detector configured to detect objects depicted in digital images;
a classifier configured to classify objects detected by the object detector;
an input for questions;
an answer set solver configured to determine answers to questions; and
an output for instructions to operate the machine depending on answers determined by the answer set solver by:
providing a digital image,
providing a structured representation of a question,
predicting with the object detector and depending on at least a part of the digital image an area of the digital image, wherein an object is depicted in the digital image,
predicting, with the classifier and depending on at least a part of the digital image within the area, a first score indicating a likelihood that the object is of a first class and a second score indicating a likelihood that the object is of a second class, wherein the first score indicates a higher likelihood than the second score,
providing at least one attribute value for the first class,
adding to an answer set programming program a first rule including the at least one attribute value of the first class and/or a first constraint including the at least one attribute value of the first class, with a condition determined depending on a mean value and a standard deviation of a distribution of scores that indicate for a plurality of classes their respective likelihood that an object of the respective class is detected by the object detector,
determining if the second score meets the condition or not,
based on the second score meeting the condition, providing at least one attribute value for the second class, and adding, to the answer set programming program, a second rule including the at least one attribute value of the second class and/or a second constraint including the at least one attribute value of the second class,
adding at least one fact to the answer set programming program depending on the structured representation of the question,
determining, with an answer set solver, an answer to the answer set programming program, wherein the answer includes at least one attribute value of the first class and/or at least one attribute value of the second class,
operating the machine depending on the answer.

14. The device according to claim 13, further comprising at least one sensor configured to capture the digital images and/or at least one actuator configured to operate the machine according to the instructions.

15. A non-transitory computer-readable medium on which is stored a computer program for operating a machine, the computer program, when executed by a computer, causing the computer to perform the following steps:
providing a digital image;
providing a structured representation of a question;
predicting with an object detector and depending on at least a part of the digital image an area of the digital image, wherein an object is depicted in the digital image;
predicting, with a classifier and depending on at least a part of the digital image within the area, a first score indicating a likelihood that the object is of a first class and a second score indicating a likelihood that the object is of a second class, wherein the first score indicates a higher likelihood than the second score;
providing at least one attribute value for the first class;
adding to an answer set programming program a first rule including the at least one attribute value of the first class and/or a first constraint including the at least one attribute value of the first class, with a condition determined depending on a mean value and a standard deviation of a distribution of scores that indicate for a plurality of classes their respective likelihood that an object of the respective class is detected by the object detector;
determining if the second score meets the condition or not;
based on the second score meeting the condition, providing at least one attribute value for the second class, and adding, to the answer set programming program, a second rule including the at least one attribute value of the second class and/or a second constraint including the at least one attribute value of the second class;
adding at least one fact to the answer set programming program depending on the structured representation of the question;
determining, with an answer set solver, an answer to the answer set programming program, wherein the answer includes at least one attribute value of the first class and/or at least one attribute value of the second class;
operating the machine depending on the answer.
